(19) United States
(12) Patent Application Publication
(10) Pub. No.: US 2013/0178108 A1
(43) Pub. Date: Jul. 11, 2013

(54) Through-Board Card Edge Connector and Component Assembly

(71) Applicants: Peter Bishop, Cambs (GB); Norman Huntley, Bishops Stortford (GB)

(72) Inventors: Peter Bishop, Cambs (GB); Norman Huntley, Bishops Stortford (GB)

(73) Assignee: AVX CORPORATION, Fountain Inn, SC (US)

(21) Appl. No.: 13/347,959

(22) Filed: Jan. 11, 2012

(51) Int. Cl. H01R 24/20

(52) U.S. Cl. 439/629

(57) ABSTRACT

A through-board card edge connector has an insulative body defining a top end and a male plug portion extending transversely from the top end. The male plug portion has outer circumferential dimensions so as to extend through a mounting hole in a first electronic component, such as a PCB. An open socket is defined in an end of the male plug portion opposite from the top end and defines a first slot having first dimensions for receipt of a first card edge, and a second slot having second dimensions for receipt of a second card edge having dimensions different than the first card edge. A spring biased connector element is disposed within the open socket and is configured to make electrical contact with an edge terminal of either of a first or second card edge inserted into either of the first or second slots.

### BACKGROUND

Various configurations of card edge connectors are known and widely available for electrically connecting edge contacts of a printed circuit board (PCB) to another board or altogether different electronic component. The design of card edge connectors is constantly evolving as electronic components and circuitry grow increasingly more sophisticated and compact, particularly cellular devices, cameras, computers, and the like.

The utility of card edge connectors is also expanding. For example, card edge connectors have recently gained acceptance and utility in the field of LED (Light Emitting Diode) applications. Reference is made, for example, to U.S. Published Patent Application Nos. 2010/0142204 and 2011/0019398 for descriptions of a card edge connector that is particularly well suited for connecting LED electrical component boards (particularly LED PCB boards) together in an abutting end-to-end configuration.

Through-board card edge connectors are also known. For example, JAE Electronics of Japan offers a two-position card edge connector (the ES3 Series) designed for LED lighting devices. The connector mounts through an LED mounting board and connects a converter board edge to the mounting board. The connector may be SMT mounted to the LED mounting board.

The present invention offers a unique, more versatile through-board connector that is particularly useful in LED lighting applications.

### SUMMARY OF THE INVENTION

Objects and advantages of the invention will be set forth in part in the following description, or may be obvious from the description, or may be learned through practice of the invention.

In accordance with aspects of the invention, an electrical connector is provided that is particularly well suited for connecting electrical component boards, such as printed circuit boards (PCB's), together in a through-board configuration. Although having particular usefulness in LED board assemblies, it should be appreciated that through-board connectors according to the invention are not limited to use with LED boards or in LED fixtures, but may used in any application wherein a secure electrical connection is desired between adjacent board components in a through-board configuration.

In accordance with certain aspects of the invention, a through-board card edge connector is provided and includes an insulative body defining a top end and a male plug portion extending transversely from the top end. The top end may have an open or closed configuration. The male plug portion has outer circumferential dimensions so as to extend through a correspondingly-shaped mounting hole in a first electronic component, which may be, for example, an LED mounting board. An open socket is defined in the end of the male plug portion opposite from the top end and defines a first slot having respective dimensions for receipt of a first card edge. The open socket also defines a second slot having respective dimensions for receipt of a second card edge having dimensions different than the first card edge. A spring-biased connector element is disposed within the open socket relative to the first and second slots so as to make electrical contact with an edge terminal on the card edge inserted into either of the first or second slots. In this manner, the card is electrically mated to and extends transversely from the plane of the first electrical component via the through-board connector.

The connector element may make electrical contact with the first electrical component in various ways. For example, the connector element may include a terminal contact that extends transversely from the top end of the body for mounting to a connector pad on the first electrical component. This may be accomplished through any suitable SMT (surface mount technology) process. In a particular embodiment, the connector may include a non-conductive mounting foot embedded in the insulative body that extends from the top end generally opposite from the terminal contact. This mounting foot mounts to a pad on the first electrical component, for example during the same SMT process.

It should be appreciated that the connector may be configured with any number of the terminal contacts. For example, the connector may be a 2-way, 4-way, or 6-way connector.

The connector has the versatility of accommodating differently sized card edges. For example, the first slot may have a greater width dimension than the second slot to accommodate a card edge having correspondingly greater width. The first slot may be disposed between the second slot and the spring biased connector element, whereby the spring biased connector element extends sufficiently across the thickness (depth) dimension of the first slot so as to contact the edge terminals of a card edge inserted into either of the first or second slots. In this embodiment, shoulders may be configured in the open socket and define a thickness dimension of the first slot, wherein a card edge inserted into the first slot is slidable along the shoulders. In the same embodiment, the second slot may have a different thickness dimension than the first slot, with the second slot having side walls and a base defined by a wall of the open socket.

In a certain embodiment, the second slot has a base defined by a wall of he open socket and an open side opposite from the base, wherein a card edge inserted into the second slot extends through the open side and into the first slot for mating contact with the spring biased connector element.

In still further embodiments, the socket may include side walls having a stepped profile such that a card edge inserted into the first slot is engaged by side walls and shoulders of the insulative body, and a card edge inserted into the second slot is engaged by side walls and a base of the socket. The stepped profile may define the same or different thickness dimensions for the first and second slots.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an embodiment of a through-board connector configured with a first card edge and board;

FIG. 2 is a perspective view of the embodiment of a through-board connector configured with a second card edge and board;

FIG. 3 is an alternate perspective view of a 6-way through-board connector configured with a card edge and board;

FIG. 4 is an alternate perspective view of a 2-way through-board connector configured with a card edge and board;

FIG. 5 is a side view of an embodiment of a through-board connector configured with a first card edge and board;

FIG. 6 is a side view of the embodiment of a through-board connector of FIG. 5 configured with a second card edge and board;

FIG. 7 is top view of an embodiment of a through-board connector;

FIG. 8 is an end view of an embodiment of a through-board connector;

FIG. 9 is a cut-away view of an embodiment of a through-board connector; and

FIG. 10 is a top view of an electrical component with a through hole and mounting pads.

### DETAILED DESCRIPTION

Reference will now be made in detail embodiments of the invention, examples of which are illustrated in the drawings. The various embodiments are presented herein for sake of explaining aspects of the invention, and should not be interpreted as a limitation of the invention. For example, features illustrated or described with respect to one embodiment can be used with another embodiment to yield still a further embodiment. It is intended that the present invention include these and other modifications and variations as come within the scope and spirit of the invention.

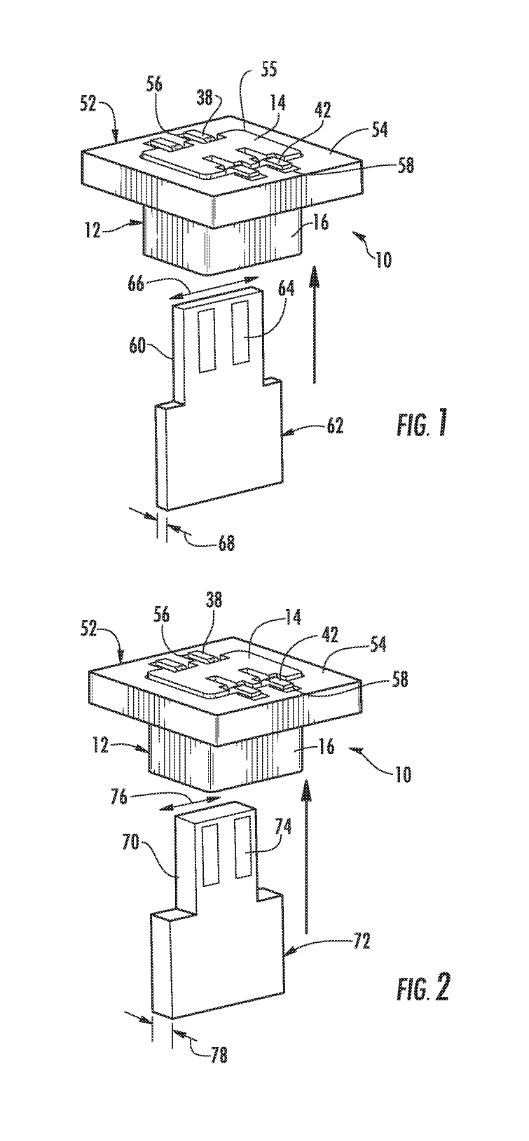

Referring to FIGS. 1 through 4 in general, an embodiment 10 of a through-board card edge connector is illustrated. As mentioned, although the connector 10 has particular usefulness for connecting components together in an LED light assembly or LED fixture, the connector 10 is not limited to such use and may be used in any application wherein a secure electrical connection is desired between adjacent board components in a through-board configuration. The connector 10 includes an insulative body 12 that may take on various shapes and sizes. The body 12 is generally formed of any suitable insulative material, such as nylon-46. Other insulative materials are well known to those skilled in the art and may be used in the components of the connector 10 of the present invention.

The insulative body 12 defines a top end 14 and a male plug portion 16 that extends generally transversely from the plane of the top end 14, as particularly depicted in FIGS. 1 through 4. The top end 14 may have an open configuration or a closed configuration (as depicted in the figures). The male plug portion 16 has an outer circumferential dimension so as to slide through a mounting hole 55 (FIG. 10) in a first electronic component 52 in which the connector 10 is engaged. In the embodiment depicted in the figures, the male plug portion 16 has a generally multi-sided circumferential shape, such as a square or rectangular shape. It should be appreciated that this shape may vary within the scope and spirit of the invention so as to engage any correspondingly shaped mounting hole 55 in an electrical component 52.

In the various embodiments depicted in the figures, the electrical component 52 mated with the connector 10 is a board component 54, such as a printed circuit board (PCB) that contains contact pads 56 for mounting with terminal contacts 38 of the connector 10, as described in greater detail below. It should be appreciated that, however, the invention is not limited to any particular type or configuration of electrical component 52 to which the connectors 10 mate, and that the illustration of a board 54 is for illustrative purposes only.

Still referring to FIGS. 1 through 4, the insulative body 12 includes an open socket 18 defined in the end of the male plug portion 16 that is opposite from the top end 14. In other words, the open socket extends longitudinally into the male plug portion 16 and is capped or sealed by the top end 14 of the body member 12. As will be described in greater detail below with respect to FIG. 8, the open socket 18 includes a first slot 20 having dimensions for receipt of a first card edge 60 (FIG. 1) and a second slot 26 having dimensions configured for receipt of a second card edge 70 (FIG. 2). The second card edge 70 has dimensions that are different than the dimensions of the first card edge 60.

Referring to FIGS. 1 and 2, cards 62 (FIGS. 1) and 72 (FIG. 2) include respective terminal contact 64, 74 at an edge portion 60, 70. The through-board connector 10 of the present invention is configured to electrically mate these terminal contacts 64, 74 with the connector pads 56 on the surface of the first electrical component 52 (i.e. circuit board 54) such that the cards 62, 72 are mounted to the board 54 in a generally transverse orientation within the circumference or outer dimensions of the board 54. In other words, the cards 62, 72 need not be mounted to the edges of the board 54, but may extend through the board 54 to connect to any configuration or footprint of connector pads 56 at any location within the boundaries of the board 54.

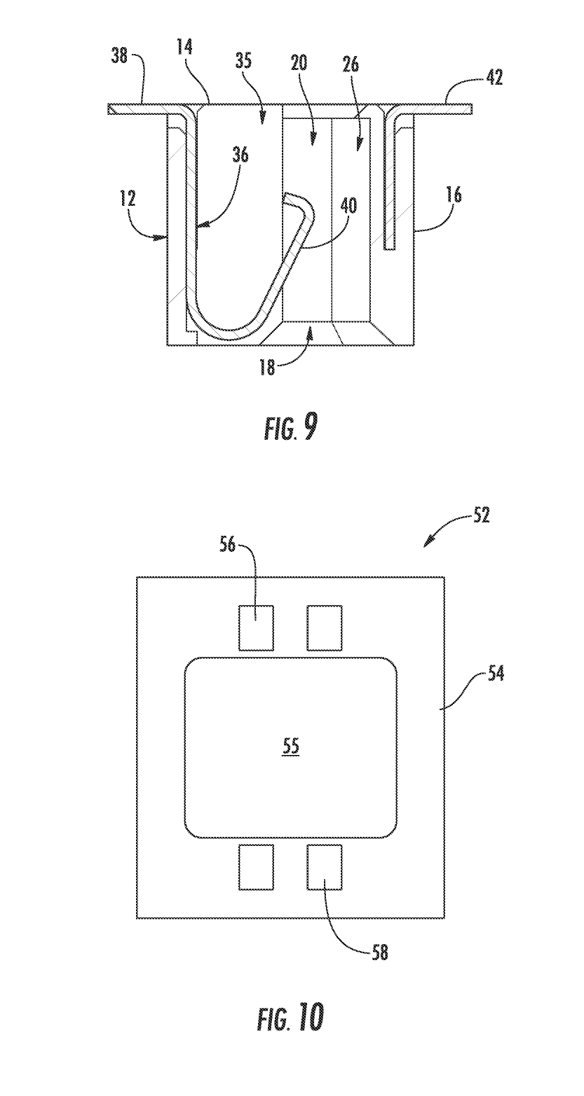

Referring particularly to FIG. 9, a spring biased connector element 36 is configured in the insulative body 12 and has a terminal end defining the contact 38 that connects to the connector pads 56 on the board 54. The connector element 36 is configured with a spring-biased head 40 within a recess 35 defined in the body 12. The head 40 may be defined by a generally U-shaped strip member portion of the connector element 36, with the other leg of the strip member defining the terminal contact 38, as particularly illustrated in FIG. 9. The connector element 36 may be press-fitted into the recess 35 and engaged by any suitable structure in the insulative body for retaining the connector element 36 securely in position. Additionally, the connector element 36 may be molded into the body 12, or retained by any mechanical means.

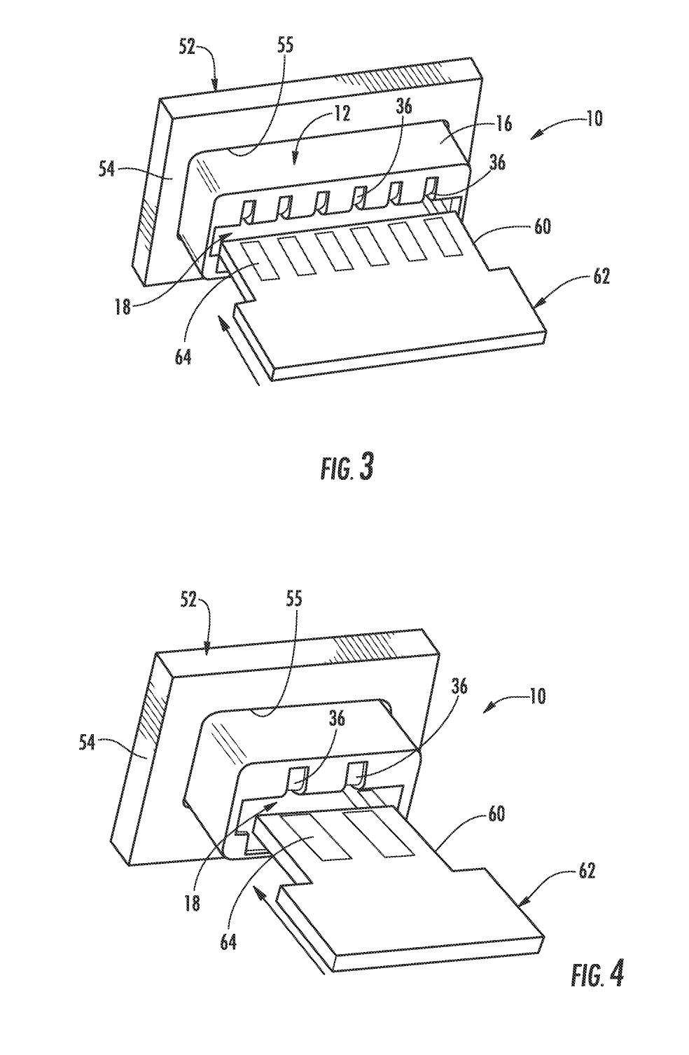

In the embodiment of FIGS. 1 and 2, two of the connector elements 36 are configured with the connector 10, while in the embodiment of FIG. 3, six of the connector elements 36 are configured within the connector 10. It should be readily appreciated that any number of the connector elements 36 may be configured in the body 12 depending on the desired contact footprint (i.e., a two-way, three-way, four-way contact, and so forth). Each of these connector elements 36 may be configured and spaced along the open socket 18 and top end 14 of the body 12 in the manner depicted in FIG. 9.

FIG. 10 illustrates an embodiment of an electrical component 52 having a two-way contact pad configuration wherein two connector pads 56 are spaced along an edge of the through-hole 55. The connector configuration 10 of FIGS. 1, 2, and 4, would be suitable for this type of component footprint configuration.

It should be appreciated that electrical connection of the terminal contacts 38 of the respective connector elements 36 may be made with the connector pads 56 of the electronic component 52 by any suitable means. The connector 10 is particularly suited for SMT (surface mount technology) processes wherein the connections are made by any manner of known SMT process.

It should also be readily appreciated that the connector elements 36 described herein are not limited to any particular construction material. In a desirable embodiment, the various connector elements 36 may be, for example, copper alloy with selective gold over nickel tin plated on the contact tails. The surface mount brackets may be, for example, a tin plated copper alloy.

Relating to the figures in general, the insulative body 12 may also include non-conductive mounting feet 42 embedded in the insulative body 12 so as to extend generally transversely from the top end 14 of the connector 10 generally opposite from the terminal contacts 38. As can be particularly seen in FIG. 9, these mounting feet 42 are embedded in the insulative body material and do not contact the terminal contacts 64, 74 of the card edges 60, 70. These mounting feet 42 are bent over the top end 14 of the insulative body and extend generally outward from the body, as do the terminal contacts 38, and serve as a secure SMT mounting feature to mounting pads 58 also provided on the board 54, as particularly seen in FIGS. 1 and 2. Thus, the connector element 10 may be secured and fixed relative to the board 52 in the same SMT process wherein the terminal contacts 38 are electrically mated to the connector pads 56 of the board 54.

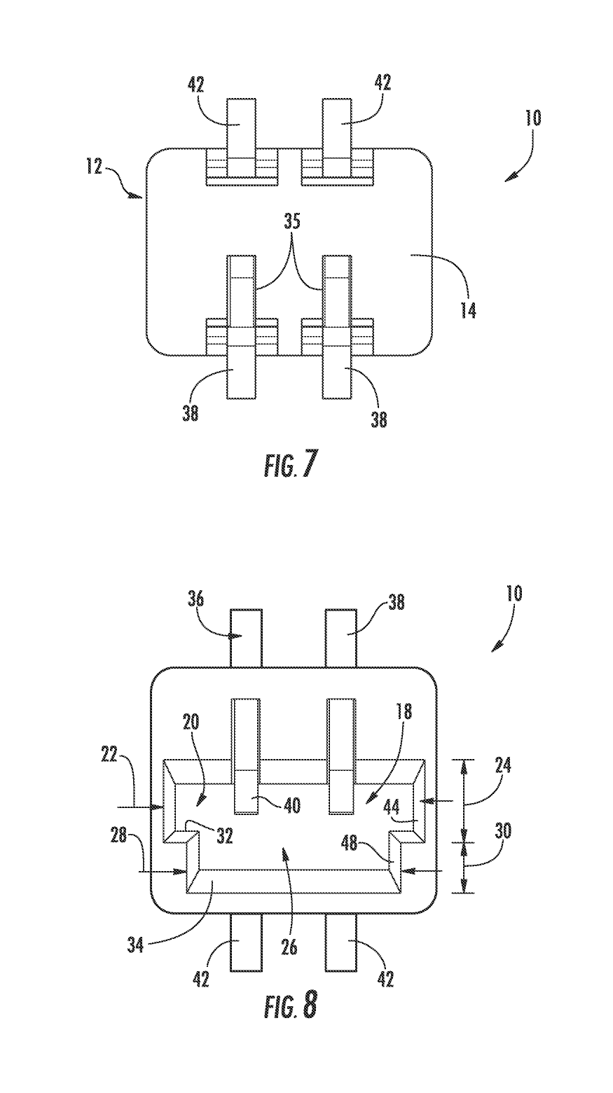

Referring to FIGS. 7 and 8 in particular, an embodiment illustrating the dimensional aspects of the first slot 20 and second slot 26 in the open socket 18 of the body 12 are illustrated. As can be seen from FIG. 8, the first slot 20 is disposed adjacent to the spring-biased heads 40 of the connector elements 36. The second slot 26 is adjacent to the first slot 20 and the slots share a common open side that extends between shoulders 32 defined in the body 12. In this particular embodiment, the first slot 20 has a greater width dimension 22 as compared to the width dimension 28 of the second slot 26. Thus, the first slot 20 may accept a card edge 60 (FIG. 1) having a greater width dimension 66 as compared to a second card edge 70 (FIG. 2) having the width dimension 76. When the card edge 60 is inserted into the first slot 20, the card edge slides along the shoulders 32 and side walls 44 of the insulative body 12 that further define the dimensions of the first slot 20. Referring to FIG. 8, the spring-biased head 40 of the connector element 36 extends into the first slot 20 and thus engages the terminal contacts 64 on the card edge 60.

Referring to FIGS. 2 and 8, the second slot 26 has a decreased width dimension 28 as compared to the first slot 20 and is defined between side walls 48 and a base 34. A card edge 70 having a decreased width 76 may be slid into this slot 26 along the base 34 and between the side walls 48. The card edge 70 has a thickness 78 that is greater than the height 30 of the side walls 48. Thus, a portion of the card edge 70 actually extends through the open side of the slot and into the first slot 20 such that the terminal contacts 74 are engaged by the spring-biased contact head 40.

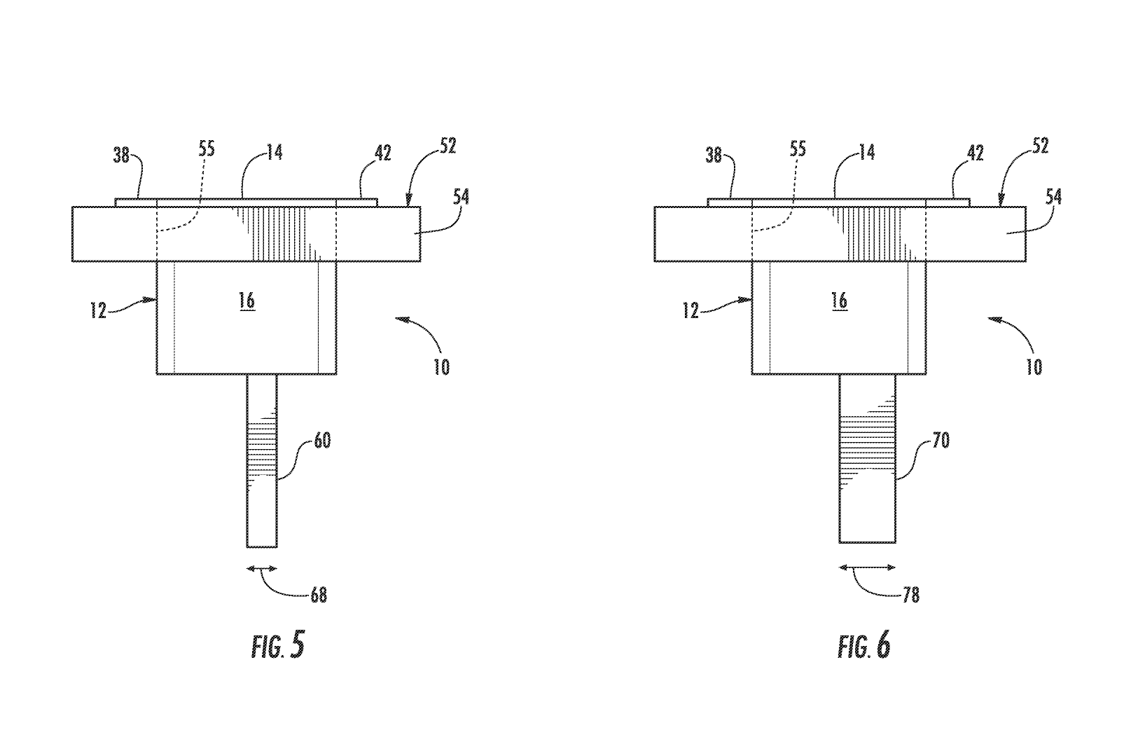

FIG. 5 is a side view of an embodiment of a through-board connector 10 in accordance with aspects of the invention with a first card edge 60 having a thickness 68 inserted into the open socket end of the body 12. Similarly, FIG. 6 is a side view of the same connector 10 having a different card edge 70 with a greater thickness 78 inserted into the open socket end of the body 12.

Referring to FIG. 8 in particular, it should be appreciated that the height or thickness 30 of the second slot 26 is a function of the thickness 78 (FIG. 6) of the intended card edge 70 and, thus, the thickness 30 may be the same as, less than, or greater than the thickness 24 of the first slot 20. In the embodiment depicted in FIG. 8, the thickness 30 is less than the thickness 24 of the first slot 20, but because of the step-profile of the side walls 44, 48, a card edge 70 having an overall greater thickness 78 is insertable into the socket 18 such that the card edge 70 slides along the base 34 yet extends through the open side of the second slot 26 and into the first slot 20 so as to be engaged by the spring-biased contact heads 40.

It should be readily appreciated by those skilled in the art that various modifications and variations can be made to the present invention without departing from the scope and spirit of the invention as set forth in the claims and their equivalents.

What is claimed is:

1. A through-board card edge connector, comprising:
an insulative body defining a top end and a male plug portion extending transversely from said top end, said male plug portion having outer circumferential dimensions so as to extend through a mounting hole in a first electronic component;
an open socket defined in an end of said male plug portion opposite from said top end;
said open socket defining a first slot having first dimensions for receipt of a first card edge;
said open socket defining a second slot having second dimensions for receipt of a second card edge having dimensions different than the first card edge; and
a spring biased connector element within said open socket and configured to make electrical contact with an edge terminal of either of a first or second card edge inserted into either of said first or second slots.

2. The connector as in claim 1, wherein said connector element comprises a terminal contact extending transversely from said top end for mounting to a connector pad on the first electrical component.

3. The connector as in claim 2, further comprising a non-conductive mounting foot embedded in said insulative body and extending from said top end generally opposite from said terminal contact for mounting to a pad on the first electrical component.

4. The connector as in claim 3, wherein said terminal contact and said mounting foot are configured for surface mounting on the first electrical component.

5. The connector as in claim 4, comprising a plurality of said terminal contacts and mounting feet configured in said insulative body.

6. The connector as in claim 1, wherein said first slot has a greater width dimension than said second slot.

7. The connector as in claim 6, wherein said first slot is between said second slot and said spring biased connector element, said spring biased connector element extending sufficiently across a thickness dimension of said first slot so as to contact the edge terminals of a card edge inserted into said second slot.

8. The connector as in claim 7, comprising shoulders in said open socket, wherein a card edge inserted into said first slot is slidable along said shoulders.

9. The connector as in claim 8, wherein said second slot has a different thickness dimension than said first slot, said second slot having side walls and a base defined by a wall of said open socket.

10. The connector as in claim 9, wherein said second slot has an open side opposite from said base, wherein a card edge inserted into said second slot extends into said first slot for mating contact with said spring biased connector element.

11. The connector as in claim 7, wherein said socket comprises side walls having a stepped profile such that a card edge inserted into said first slot is engaged by side walls and shoulders of said socket, and a card edge inserted into said second slot is engaged by side walls and a base of said socket.

12. The connector as in claim 11, wherein said first and second slots have different thickness dimensions.
